(19) United States
(12) Patent Application Publication
(10) Pub. No.: US 2008/0215372 A1
(43) Pub. Date: Sep. 4, 2008

(54) Device and Method for Continuity of Care in a Health Care Environment

(76) Inventor: Abhijit Ray, Kansas City, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/041,637

(22) Filed: Mar. 3, 2008

Related U.S. Application Data
(60) Provisional application No. 60/892,829, filed on Mar. 2, 2007.

(51) Int. Cl. G06F 19/00

(52) U.S. Cl. 705/3

(57) ABSTRACT

The present invention is directed to a method and device for ensuring patient continuity of care. One aspect of the present method includes providing to a patient a hand-held portable device that has at least a portion of the patient's medical record stored thereon. The patient can then carry the hand-held portable device on his person for access of the information thereon whenever necessary or desired.

### RELATED APPLICATIONS

This application claims benefit of U.S. Provisional Patent Application No. 60/892,829 filed on Mar. 2, 2007, and incorporated herein by reference in its entirety.

### BACKGROUND OF THE INVENTION

1. Field of the Invention

The present invention relates generally to the health care professions, and more specifically to a device and method for ensuring continuity of care in the health care professions.

2. Description of the Prior Art

Health care information transportability is key to an efficient, effective health care system. When a patient is referred from one physician to another, transferred from one physician to another, or simply seen by a physician other than the patient's regular physician due to an emergency or otherwise unplanned visit, the physician who is seeing the patient must retrieve medical information about the patient from other health care providers. The information that must be retrieved includes, but is not limited to, patient biographical information, information regarding other providers, insurance information, information regarding recent care, current or future plans for care, reasons for referral or transfer, and, of course, patient-specific medical information such as diagnoses, allergies, medications being used, recent medical procedures, vital signs, and the like. The retrieval of a patient's past medical history is a time-consuming and challenging process. In an emergency medical situation, both time and accuracy are of the highest priority. In non-emergency situations wherein more time is afforded, accuracy remains paramount and lengthy retrieval times for medical information, or the inability to access information at all, contributes to the inefficiency of the system.

Given the technological advances of the digital age, however, there is some danger inherent in transporting such vital information. Identity theft and insurance fraud are but two examples of the potential negative consequences of allowing free and open transport of health care information between providers. Therefore, any device or system for transporting sensitive information should include safeguards against the unauthorized acquisition or use of the information.

What is needed, then, is a device and system via which a patient is able to carry health care records on his person, for immediate access in a medical or other emergency where such records are needed. Further, what is needed is a device and system for the secure and confidential transport of such information, wherein loss of the device does not result in the compromising of the information stored therein.

### SUMMARY OF THE INVENTION

The present invention is directed to a method and device for ensuring patient continuity of care. One aspect of the present method includes providing to a patient a hand-held portable device that has at least a portion of the patient's medical record stored thereon. The patient can then carry the hand-held portable device on his person for access of the information thereon whenever necessary or desired.

Another aspect of the present method includes providing the hand-held portable device with the capability of obtaining biometric data from a patient, and providing the hand-held portable device with the capability of comparing that patient biometric data to other biometric data for the purpose of verifying the identity of the patient.

Another aspect of the present invention provides a device for storing a patient electronic medical record. The device includes a housing and an electronic memory portion, at least a portion of a medical record being stored on the electronic memory portion. The device is sized and shaped such that a patient can carry the device on his person for retrieval of the at least a portion of a medical record therefrom.

Another aspect of the present invention provides an interface portion in electronic communication with the memory portion. The interface portion is adapted to communicate with an external computer for the purpose of transmitting the at least a portion of a medical record.

Another aspect of the present invention provides that the electronic medical record information stored on the device is stored in encrypted form.

Another aspect of the present invention provides that the interface portion is a USB port.

Another aspect of the present invention provides a display in electronic communication with the memory portion, the display adapted to display the at least a portion of a medical record thereon.

Another aspect of the present invention provides a navigation portion for navigating the information displayed on said display.

### BRIEF DESCRIPTION OF THE DRAWING FIGURES

FIG. 1 is a flow-chart showing exemplary components of one embodiment of the present invention, as well as bi-directional information flow between the same.

FIG. 2 is a flow-chart showing an exemplary enrollment and verification method of the present invention.

FIG. 3 is a schematic representation of an exemplary device of the present invention.

### DETAILED DESCRIPTION OF THE PREFERRED EMBODIMENTS

The present invention provides a device and method for ensuring continuity of information among multiple health care providers with respect to any given patient. The present invention further provides for secure and confidential information transport, such that if a device of the present invention is lost or stolen, the information contained therein is not necessarily compromised.

The present method preferably includes a number of components that are integrated to provide an overall scheme for ensuring continuity and quality of care for a patient. The components of the method include, but are not limited to, a device for maintaining an off-line health record and a web-based electronic medical record.

Off-Line Health Record

The present device is preferably a flash-memory based portable device that is capable of storing patient biographical information, current medication information, allergy information, insurance information, and any other such information deemed necessary or desirable to ensure efficient continuity of care. The present device is preferably carried by a patient in real time, ensuring that every physician, clinic, hospital, or other health care provider has immediate access to complete, accurate, and timely information regarding the patient's medical history and condition.

Data is preferably stored in the present device using XML format, although it is contemplated that any of various document or information formats may be used without departing from the scope of the present invention. Other formats that may be utilized include, but are not limited to, JSON, YAML, xqML, HTML, GML, SGML, and the like. Any suitable format, either now-known or developed hereafter, may be used.

The present device further preferably includes Radio Frequency Identification (RFID) technology as well as biometric technology, to ensure that the identity of a person having the present device is verified. The RFID technology may be of the passive or active form, although it is preferred that passive RFID is used and that the present device must be located near to a reader before any information can be obtained from the device. The device and reader also preferably communicate without the need for contact, by any suitable wireless communication method such as, for example, Bluetooth. It is contemplated, however, that in some embodiments of the present invention, the present device will have to be plugged in to or otherwise inserted into a reader before any information can be obtained from the device.

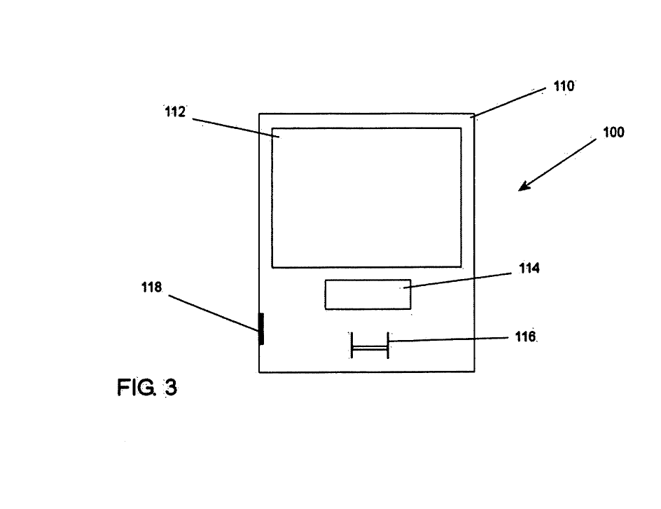

In addition to the RFID technology described above, the present device also preferably includes biometric information specific to a given patient, such that when a patient arrives at a medical or health care facility and presents the device to the health care provider, the patient's biometric information may be compared to that contained by the present device such that the identity of the patient may be confirmed. The device itself may include a biometric sensor reader such as, for example, a fingerprint reader (as in the case of device 100 shown in FIG. 3 and described below), or a biometric reader may be provided at the clinic, hospital, or other health care provider location, such that biometric data may be read at that location and then compared with information in the device. Any suitable biometric data, either now-known or developed hereafter, may be utilized. Biometric data that may be utilized in conjunction with the present device includes, but is not limited to, fingerprint data, eye retina and iris data, facial pattern data, and hand measurement data.

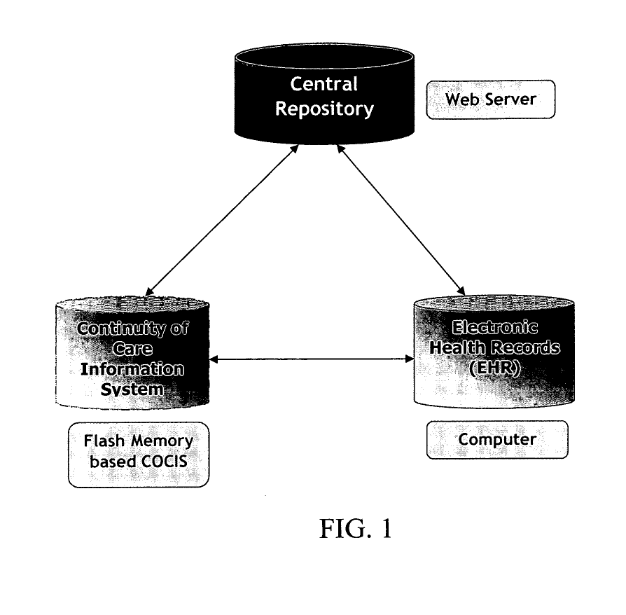

The present device and method preferably utilize a dual infrastructure model. A diagram of an exemplary structure of such a model is provided in FIG. 1. As shown in the figure, health care information is preferably located within a central repository such as a web server. Health care information is also preferably contained within a portable device of the present invention, such as a flash-memory based device, as well as in an electronic medical records system on, for example, a computer located at a health care provider's location. Two-way communication is preferably allowed between each of the above-described components, and a user or administrator of the present invention may prescribe rules governing how data between the three is synchronized, how conflicts are resolved, and the like.

Web-Based Electronic Medical Record

The present system preferably includes a web-based electronic medical record such that information contained within a patient medical record may be provided instantaneously (or near to it) across any geographical distance. The web-based online medical record may store such information as patient demographics, allergies, medical problems, immunizations, prescribed medications, and the like. Any necessary or desirable information may be included to form a Global Health Record (GHR). The GHR is preferably updated by clinical systems making use of the present invention, as well as by the portable continuity of care device of the present invention. In the latter instance, a patient or provider may synchronize the portable device with the GHR to include the newest information, using any computer connected to the internet or other suitable network. Therefore, both the portable device and the GHR will contain the most up to date patient information, while at the same time maintaining older information as a historical record of the patient. The present portable device may communicate with the computer by any suitable method, including communication via USB ports, removable flash or other memory cards, Bluetooth technology, and the like. This synchronization ensures that both online and offline media contain accurate and complete information regarding the patient.

Data and System Security

Any portable device carrying health care or other personal information raises the possibility that unauthorized individuals who obtain the portable device will be able to access the information contained therein. The present device and method ensures protection of the information through a series of policies, procedures, and safeguards, described below. These policies, procedures, and safeguards enable a user of the present invention to maintain the integrity and availability of the information and control access thereto.

One feature of the present invention that accounts for the user of individually-identifiable health care information is an auditing feature. The auditing feature of the present invention keeps track of system information and examines system activity. Auditing of any interaction with patient health care information maintained by the present invention is preferably recorded within the system itself. The recorded information may include, for example, the date and time of the information access event, the user logged into the system at the time of the access, the area within the present system in which the auditing occurred, and other detailed information dependent upon the type of interaction implemented by the auditing system.

Further, in addition to recording interactions with the present system, the health information contained within the present system is preferably backed up regularly to a centralized server, which may in turn be backed up in any suitable manner to ensure that information contained within the system is not lost if the portable device of the present system fails, or if the other components of the system fail. It is preferred that any information lost as a result of hardware or software failure may be easily restored from back-up sources associated with the present device and system.

Another aspect of the present invention is an encryption feature. Such cryptographic encoding is a primary tool for protecting data that is stored and transmitted over communication lines. The function of the encryption feature of the present invention is to provide confidentiality, integrity, authentication, non-repudiation, and access control. Further, the encryption feature of the present invention serves to prevent unauthorized disclosure of a patient's health care information across a network, thereby meeting HIPAA requirements.

The present invention further preferably includes a digital signature aspect, whereby information contained within the system and associated portable device cannot be altered without permission. The digital signature function validates the integrity of the message and the sender. For example, when any signal to modify information is sent to the present system or the portable device associated therewith, the message itself is encrypted using the encryption feature of the present invention, thereby ensuring that unauthorized sources will not be able to obtain access to the contents of the message. The present device and method includes verification of the digital signature prior to making any modifications to the information contained within the device or system. With respect to the encryption feature of the present invention, it is contemplated that many methods of data encryption are known in the art, and that any suitable method of encryption, whether now-known or developed hereafter, may be utilized in conjunction with the present invention.

The present invention further preferably includes an access control feature, which serves to prevent unauthorized access to the system. The present invention preferably utilizes a Discretionary Access Control (DAC) model to allow the ‘owner’ of a resource to establish privileges for the information they own. The DAC model, therefore, allows an individual to share information, or to utilize information they own or that someone else has shared with them. An access control list is established, the list serving to identify the users who are authorized to received any given information. The model is dynamic and allows for the easy sharing of information between users.

In another aspect of the present invention, differential access to information is provided based on the authorization of the person seeking access. For example, a registration clerk at a clinic or hospital may require access to patient demographics or insurance information, but may not need access to specific clinical information. Based upon the clerk's authorization, the present device and method will only provide the clerk with the needed and authorized information, keeping the other information secure and inaccessible.

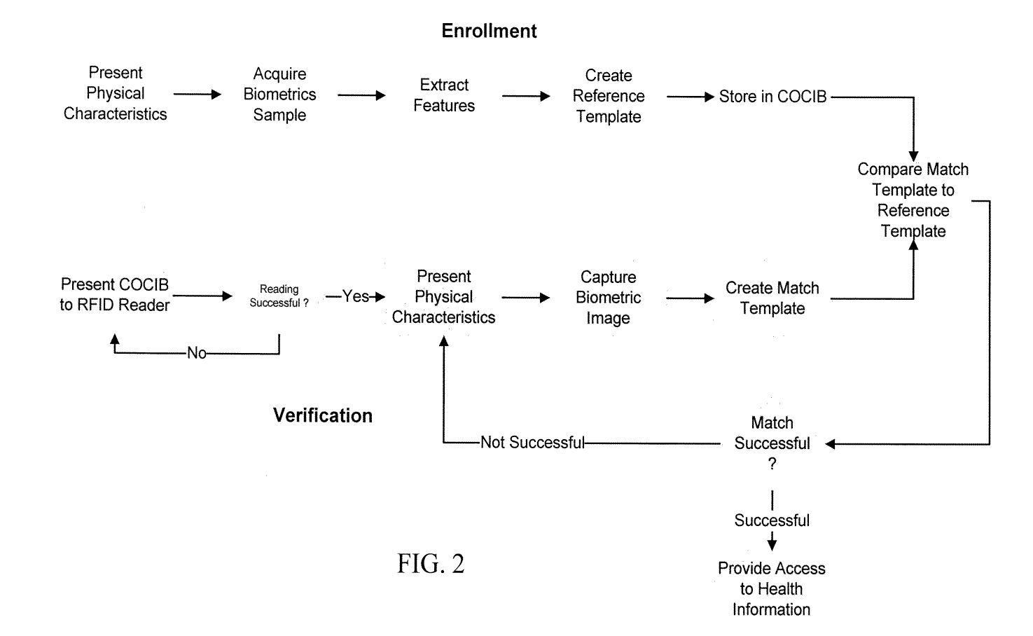

FIG. 2 provides an exemplary embodiment of an identification, authentication, and authorization process of the present invention. As can be seen from the figure, an enrollment process is provided by which a user's initial biometric sample or other digital information is collected, assessed, processed, and stored for ongoing use in the system. The biometric sample acquired may be, for example, an identifiable fingerprint. Any suitable biometric data may be used. The biometric data is then used to generate biometric templates that may be used by the present device and system. Such templates are generated by first locating and encoding distinctive characteristics from a biometric sample. This feature extraction process may include varying degrees of image or sample processing in order to locate a sufficient amount of accurate data. A comparatively small but highly distinctive file is then derived from the user's biometric data to generate a template for use in performing biometric matches. This template is stored by the present device and system for use in future biometric comparisons. Biometric information may be obtained from a patient using the present invention to ensure that access to information contained within the present device and system is protected from unauthorized access. It is contemplated that methods of extracting, storing, and comparing biometric data are well-known in the art, and that any such suitable methods may be used in conjunction with the present invention.

The matching process for verifying biometric information is generally the same as that for developing stored biometric information. A template is generated as described above at the time and individual wishes to access information contained within the present device or system. The template thus generated is compared to the templates stored within the present device or system in order to verify the identity of the user seeking access. After the comparison is made, the newly-generated template is discarded.

The hardware specifications of the present portable device are variable, it being contemplated that any suitable device may be adapted to incorporate the principles of the present invention. Described below are exemplary, but not limiting, features of the present portable device.

A portable device of the present invention may utilize, for example, 16, 32, or 64 bit processors. Any suitable processor or processors may be used. Reduced instruction set (RISC) microcontrollers may also be utilized, providing high speed of operation over a limited range of functions.

Memory contained within the present device is also variable. Read-only memory (ROM) may be used for storing a fixed program (also known as a mask) required by the present invention. A portion of the ROM may also be available for application programs. ROM is efficient in terms of both power and space requirements.

Programmable read-only memory (PROM) may be used for loading personal index numbers of for other fixed values for positive identification. PROM is generally small and accounts for little space or power usage.

Flash memory is a type of nonvolatile memory capable of retaining digital information. The memory subsystem optimizes density, preserves critical material in a nonvolatile condition, is fast to read, easy to program an reprogram, and is cost effective. The stored blocks of data can be read, written, and extracted all at the same time using a normal communications interface. Thus, flash memory is preferably used for storing the patient-specific health care information of the present invention.

Random-access memory (RAM) is used for temporary working storage. The portable device of the present invention may utilize RAM where desirable. The information contained within RAM is lost when the present device loses power.

Antennas used by the present invention are preferably of the input-output variety, and powered by radio-frequency (RF) signals. In one embodiment of the present invention, a coil antenna is built into the portable device so that the portable device may communicate with the reader.

FIG. 3 provides a general schematic diagram of one embodiment of a device of the present invention. Device 100 includes a housing 110, within which the various electronic components of the present device are contained. Device 100 also preferably includes a display 112, such as, for example, an LCD display for displaying health care information contained within device 100 to a user thereof. Device 100 further includes a navigation portion 114. Navigation portion 114 is shown in the schematic of FIG. 3 as a rectangular box. Any suitable navigation portion may be used, and it is contemplated that various navigation portions are well-known in the art. Navigation portion 114 may include, for example, a button or plurality of buttons, a pressure or heat-sensitive touchpad, a joystick-like navigation structure, or any other suitable structure for navigation. Manipulation of navigation portion 114 allows a user of device 100 to access and navigate the information contained within device 100, said information being displayed on display 112.

The embodiment of device 100 shown in FIG. 3 also includes a biometric reader 116. Biometric reader 116 may be, for example, a fingerprint reader. By moving a finger along biometric reader 116, a user may input fingerprint data into device 100 for storage or verification procedures. Device 100 is capable of comparing the fingerprint data obtained via biometric reader 116 to fingerprint data already stored within device 100 in order to authenticate a user's identity prior to allowing access to information contained within device 100. Any suitable biometric verification device of method may be used in conjunction with device 100.

Finally, the embodiment of the present invention shown in FIG. 3 includes a port 118 associated therewith. Port 118 is preferably a USB port, but may be any type of port commonly associated with computers and other electronic devices, including, but not limited to, audio-in, audio-out, Ethernet, or other ports. Also, a port for a DC adapter may be provided for charging a battery associated with the present device. It is contemplated that the association and use of such ports with electronic devices like device 100 is well-known in the art, as are the use of rechargeable batteries. Although FIG. 3 shows only one port associated with device 100, it is contemplated that any suitable number of ports may be used.

It is contemplated that the present invention may be used by any individual requiring immediate access to secure and accurate health care records. Such users may include, apart from the patient herself, fire fighter, paramedics, police, or other first-responders. The portability of the present system allows for such usage, while the security features of the present invention, described above, maintain the integrity, privacy, and security of the information.

It is further contemplated that software associated with the present device and method may provide functionality such as allowing viewing of a medical record of other information contained within the system, as well as entry of new data into the system or modification of the data already in the system. Such software functionality may also include the ability to initiate a back-up of the information stored within the present device or system or may allow a user of the present device to copy information contained therein to, for example, a local computer hard drive. The precise graphical user interface associated with the software of the present device and system is not limiting, and those of skill in the art will be able to implement the needed software features of the present device and system upon reading this disclosure. Software used to view, enter, modify, or store data contained within the present system may be located on a desktop or laptop computer associated with the present system, may be web-based, may be associated with the portable device of the present system, or may be provided in any other suitable manner.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. Such modifications are also intended to fall within the scope of the appended claims.

Having thus described the preferred embodiment of the invention, what is claimed as new and desired to be protected by Letters Patent includes the following:

1. A method for ensuring patient continuity of care, the method comprising the step of:
a) providing to a patient a hand-held portable device having at least a first portion of said patient's medical record stored electronically therein, such that said patient can carry said at least a portion of said patient's medical record on said patient's person for access by said patient or another authorized individual when access is desired.

2. The method of claim 1 further comprising the steps of
a) providing said hand-held portable device with the capability of obtaining biometric data from said patient; and
b) providing said hand-held portable device with the capability of comparing said biometric data capable of being obtained in step a), above, with other biometric data for the purposes of verifying the identity of said patient.

3. A device for storing a patient electronic medical record, the device comprising:
a housing; and
an electronic memory portion within said housing, said electronic memory portion adapted to retain at least a portion of a medical record in electronic memory,
wherein said device is sized and shaped such that a patient may carry said device on his person for retrieval of said at least a portion of a medical record therefrom.

4. The device of claim 3, further comprising:
an interface portion in electronic communication with said memory portion, said interface portion adapted to communicate with an external computer for the purpose of transmitting said at least a portion of a medical record thereto.

5. The device of claim 3 wherein said at least a portion of a medical record is stored within said electronic memory in encrypted form.

6. The device of claim 4 wherein said interface portion is a USB port.

7. The device of claim 3 further comprising a display in electronic communication with said memory portion, said display adapted to display said at least a portion of a medical record thereon.

8. The device according to claim 7 further comprising a navigation portion adapted to allow a user to navigate data displayed on said display.

9. The method according to claim 1 further comprising the steps of:
b) providing a web-based electronic medical record, said electronic medical record containing at least a second portion of said patient's medical record;
c) receiving from said hand-held portable device said at least a second portion of said patient's medical record;
d) transferring to said hand-held portable device from said web-based electronic medical record said at least a first portion of said patient's medical record; and
e) synchronizing said web-based electronic medical record and said hand-held portable device such that any overlap of information between said at least a first portion of said patient's medical record and said at least a second portion of said patient's medical record is resolved by replacing an older portion of information with a newer portion of information.

10. The method according to claim 9 further comprising the steps of:
c) receiving into said web-based electronic medical record from a host computer associated with a health care provider at least a third portion of said patient's medical record;
d) transferring to said host computer from said web-based electronic medical record said at least a first portion of said patient's medical record and said at least a second portion of said patient's medical record; and
e) synchronizing said web-based electronic medical record and said host computer such that any overlap of information between said at least a first portion of said patient's medical record, said at least a second portion of said patient's medical record, and said at least a third portion of said patient's medical record is resolved by replacing an older portion of information with a newer portion of information.

11. The method according to claim 1 further comprising the steps of:
c) receiving into said hand-held portable device from a host computer associated with a health care provider at least a second portion of said patient's medical record;
d) transferring to said host computer from said hand-held portable device said at least a first portion of said patient's medical record; and
e) synchronizing said hand-held portable device and said host computer such that any overlap of information between said at least a first portion of said patient's medical record, said at least a second portion of said patient's medical record is resolved by replacing an older portion of information with a newer portion of information.

12. The device according to claim 3 further comprising wireless internet connectivity capability.

13. A method of providing secure continuity of care in a health care environment, the method comprising the step of:
a) providing to a patient a hand-held portable device having at least a first portion of said patient's medical record stored electronically therein, such that said patient can carry said at least a portion of said patient's medical record on said patient's person,
said hand-held portable device being adapted to read and store at a first point in time first biometric data from said patient, said hand-held device further being adapted to read and store at a second point in time second biometric data corresponding to said first biometric data, said hand-held device further being adapted to compare said first and second biometric data,
wherein said hand-held device is programmed to allow access to said at least a portion of said patient's medical record when said first biometric data and said second biometric data match to confirm the identity of said patient.
